(19) United States
(12) Patent Application Publication
(10) Pub. No.: US 2015/0016925 A1
(43) Pub. Date: Jan. 15, 2015

(54) DRILLING-PIPE HANDLING APPARATUS AND METHOD

(71) Applicant: Canrig Drilling Technology Ltd., Houston, TX (US)

(72) Inventor: Brendan Larkin, Yorkshire (GB)

(73) Assignee: Canrig Drilling Technology Ltd., Houston, TX (US)

(21) Appl. No.: 14/375,383

(22) PCT Filed: Jan. 31, 2013
(86) PCT No.: PCT/US2013/024012

§ 371 Date: Jul. 29, 2014

(30) Foreign Application Priority Data
Jan. 31, 2012 (GB) GB 1201607.7
Aug. 22, 2012 (GB) GB 1214945.6

(51) Int. Cl. E21B 19/15; B66C 1/00

(52) U.S. Cl. CPC E21B 19/15; B66C 1/00
USPC 414/22.63; 414/800

(57) ABSTRACT

A drilling-pipe handling apparatus and a method for handling drilling-pipes in a drilling rig, and is concerned particularly with apparatus and a method for racking drilling-pipes in an oil drilling rig. The pipe handling apparatus includes a pipe engaging portion, a movable positioning unit for moving the pipe engaging portion, and a mounting member for mounting the apparatus on a leg of a drilling mast.

### CROSS-REFERENCE TO RELATED APPLICATION

This application is a United States national phase application of co-pending international patent application number PCT/US2013/024012, filed Jan. 31, 2013, which claims priority to and the benefit of GB Application No. 1201607.7 filed Jan. 31, 2012, and claims priority to and the benefit of GB Application No. 1214945.6 filed Aug, 22, 2012, the disclosure of which is incorporated herein by reference.

### FIELD

The present invention relates to a drilling-pipe handling apparatus and a method for handling drilling-pipes in a drilling rig, and is concerned particularly with apparatus and a method for racking drilling-pipes in an oil drilling rig.

### BACKGROUND

An example of a land based oil drilling rig is shown in FIG. 1. The rig typically comprises a steel mast, or derrick, shown generally at 10, having four legs 12a-d forming a box-like tower, which is open on one side and braced on the three other sides. At the top of the mast is a lifting device in the form of a winch system 14, comprising a stationary portion, known as the crown block 16, and a moveable portion, known as the travelling block or travelling assembly 18. The mast is mounted on a substructure 20 comprising a platform or drill floor 22, having an aperture at its centre, which is known as the well centre 24.

Drilling is effected by drill pipes 26 shown in FIG. 2. The pipes 26 are connected together end-to-end to form a drill string, the lowermost pipe being attached to a drill bit 28. The drill pipes comprise hollow steel tubes, with threaded collar portions 30 of male and female kinds 30a and 30b at their ends for coupling the pipes together. The pipes are typically approximately 10 m in length and are usually coupled together in twos or threes, to form what is called a stand, which may be 30 m or so in length. FIG. 2a shows in greater detail the coupling of two pipes

The stands are lowered into, or lifted from, the well centre by the travelling assembly. The drill string is rotated by a rotational driver (not shown) to effect drilling, with new stands being added at the well centre as the drill gradually cuts deeper into the ground.

When the stands are not in use they are rested on their ends in an area of the substructure known as the set-back 32, which usually comprises a deck of wood, so as to protect the threaded collars against damage. Towards their upper ends the stands are supported in partitioned rows in a so-called racking board 34 so that they can be accessed one by one when they are needed. The racking board is typically mounted on the side of the mast at between half and two thirds of the way up the mast.

When the rig is first established, individual drill pipes are first lifted into the mast by the travelling assembly. Two or three pipes will then be connected together to form stands. The stands are then rested in the set back area with their upper ends located in the racking board 34.

When drilling is to begin, the stands must be maneuvered into the well centre for attachment to the travelling assembly. Stands are added as drilling reaches ever greater depths. When drilling is finished, or when a drill bit or pipe must be replaced, the reverse operation takes place. The stands are lifted from the well, de-coupled and maneuvered into their stored positions in the set back area and racking board.

Historically the maneuvering of pipes and stands between the well centre and the set back has been performed manually by an operative located on a walkway in the centre of the racking board known as a monkey board. The task can be a hazardous one, not least because the operative is working with heavy pipes at a height of tens of metres above ground, but also because the travelling assembly, a heavy piece of apparatus, travels up and down at high speed close to where the operative is working.

Because of this in recent years there have been attempts to mechanize, and even automate, the procedure of racking and retrieving drill pipes/stands. Previously considered apparatus for this purpose typically comprises a heavy duty racking module having a frame which at least partly spans the interior of the mast above the racking board, and which features a carriage mechanism arranged for two dimensional movement, on which is mounted a hydraulic gripping arm for gripping and lifting the stands into place.

There are several disadvantages with this type of racking apparatus. Firstly, because the apparatus is large and heavy, the mast itself must also be sufficiently massive to support it. This usually means that it takes more time to install and eventually remove the apparatus when a drilling operation is complete. In land drilling operations, as compared for example with offshore drilling, smaller, readily portable, rigs are preferred, so that once a drilling operation is complete the entire installation can quickly be moved to another site.

Another disadvantage with existing mechanical and automated racking apparatus is that, when the automation or mechanisation fails, often the only option is to revert to manual handling. With some previously considered automated racking systems even this option is not available due to the geometry of the apparatus preventing access to the well centre when the racking system is inoperative.

The above drawbacks are costly as they lead to increased down-time, when the rig is not actually drilling. This is unprofitable for the drilling company and must be kept to an absolute minimum.

It is therefore desirable to provide a racking system which, though sufficiently strong and stable, is relatively light in weight, readily demountable and capable of allowing manual operation in the event of failure.

### SUMMARY

Embodiments of the present invention aim to address these problems.

The present invention is defined in the attached independent claims to which reference should now be made. Further, preferred features may be found in the sub claims appended thereto.

According to one aspect of the present invention, there is provided pipe handling apparatus for handling drilling pipes, the apparatus comprising a pipe engaging portion, a movable positioning unit for moving the pipe engaging portion, and a mounting member for mounting the apparatus on a leg of a drilling mast.

Preferably the apparatus is mountable on a single leg of a mast. Alternatively the positioning apparatus is mountable on a pair of legs of a drilling mast.

The positioning unit may be arranged in use to move the pipe engaging portion circumferentially and preferably also radially with respect to the mounting member, and or with respect to the leg or pair of legs.

The pipe engaging portion may comprise a gripping member for gripping a drilling pipe, and at least one retaining member for retaining a drilling pipe. The gripping member and the or each retaining member may be mounted for mutual movement away from and towards one another, so as to raise and lower a pipe.

The positioning unit may also be arranged in use to move the pipe engaging portion translationally, rotationally and up and down with respect to the legs of the drilling mast. In a preferred embodiment the pipe engaging portion comprises a gripping member allowed to move translationally, rotationally and up and down with respect to the legs of the drilling mast.

In a preferred arrangement the gripping member and the retaining member are mounted for telescopic or slidable engagement with respect to each other. One or both of the gripping member and the retaining member may be mounted on a hydraulic actuator or on a screw.

The pipe engaging portion may additionally comprise a guide head. Suitable guide head would include a single hook shaped arm.

The gripping member may comprise gripping jaws or dies. The retaining member may comprise a collar and may comprise a retaining finger.

The positioning unit may comprise a positioning arm, and preferably comprises an upper arm portion having a proximal end which is connected to the mounting member, and a distal end which is connected to the pipe engaging portion. In a preferred arrangement the proximal end of the upper arm portion is pivotally connected to the mounting member. The distal end of the upper arm portion is preferably pivotally connected to the pipe engaging portion.

The positioning arm preferably comprises a lower arm portion having a proximal end which is connected to the mounting member and a distal end which is connected to the pipe-engaging portion.

In a preferred arrangement the proximal end of the lower arm portion is pivotally connected to the mounting member. The distal end of the lower arm portion is preferably pivotally connected to the pipe engaging portion.

The positioning arm is preferably connected to lifting/lowering means, which preferably comprises an hydraulic actuator.

Alternatively or additionally, the positioning unit may comprise a carriage frame attached to the mounting portion and preferably rotatably mounted thereon. The carriage frame may carry a drive rack which is arranged for translational movement with respect to the carriage frame.

The mounting member may be mountable for rotary movement with respect to a leg of the mast, which movement preferably allows pivoting movement of the positioning arm with respect to a leg of the mast. Rotary movement of the mounting member may be effected by one or more rotary actuators.

In a preferred arrangement the positioning unit is mounted for pivotal and/or rotational movement with respect to the leg.

The mounting member may comprise an extension member for spacing the positioning arm further from a leg of a mast.

In a preferred arrangement the apparatus comprises one of a pair of such apparatus, each of which is mounted in respect of a leg of a drilling mast.

The apparatus is preferably mechanically, and more preferably hydraulically, operable. One or more movement types of the apparatus, or all of them, may be automated, which automation may be under the control of a computer.

The apparatus may include a rack for storing drilling pipes. The rack may comprise a plurality of slots for accommodating plural pipes. The slots may be defined by elongate fingers, which fingers are preferably arcuate and may be arranged in parallel. The slots are preferably arranged in a substantially parallel, radial configuration. In a preferred arrangement the rack is provided with two sets of slots which is arranged in a radial configuration, the radii having different centres.

In addition the apparatus is suitable for use in the conventional ‘X-Y’ style racking system or arrangement.

The invention also provides a method of transporting drilling pipes between a pipe storage location and an operational location in a drilling rig, the method comprising releasably engaging a pipe with pipe engaging means and using a positioning unit to move the pipe engaging means in at least radial and circumferential directions with respect to a leg of a drilling mast on which the unit is mounted.

Preferably the method comprises gripping the pipe using a gripping member, and retaining the pipe using a retaining member, of the pipe engaging means.

The method may include moving the gripping member and the retaining member telescopically with respect to each other.

The method may include transporting the pipes mechanically, and preferably in an automated manner under the control of a computer.

In a preferred arrangement the method comprises transporting the pipes between a racking board and a well centre of a drilling rig. The method may comprise transporting the pipes to and from a racking board at least partly in a radial motion so that the pipes are placed in or removed from a racking board having one or more radially configured pipe-accommodating slots.

The invention also includes a drilling rig comprising pipe handling apparatus according to any statement herein.

### BRIEF DESCRIPTION OF DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

The invention may include any combination of the features and limitations disclosed herein, except such a combination of features as are mutually exclusive.

A preferred embodiment of the present invention will now be described, by way of example only, with reference to the accompanying diagrammatic drawings, in which:

FIG. 1 shows schematically a land-based drilling rig according to the prior art;

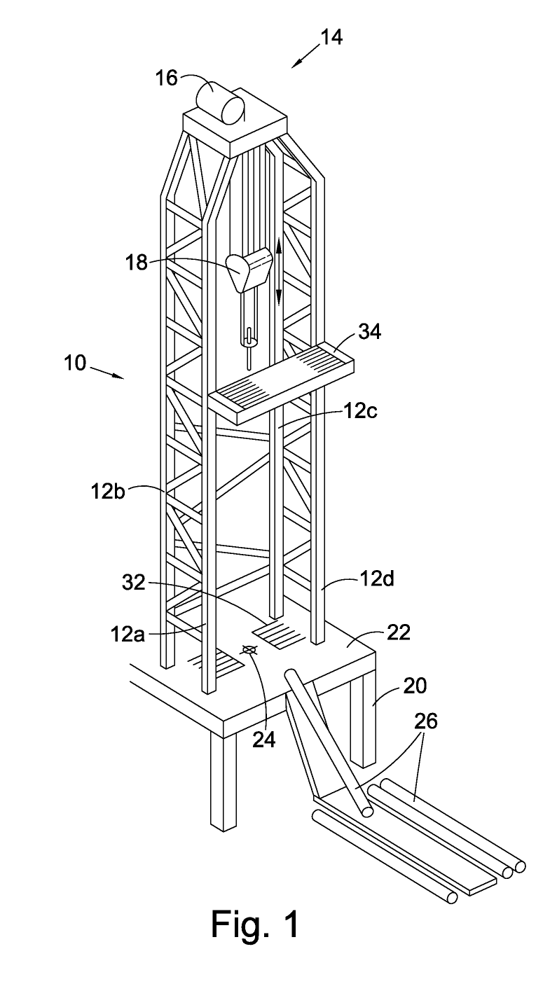

FIGS. 2 and 2a show drill pipes for use with a drilling rig;

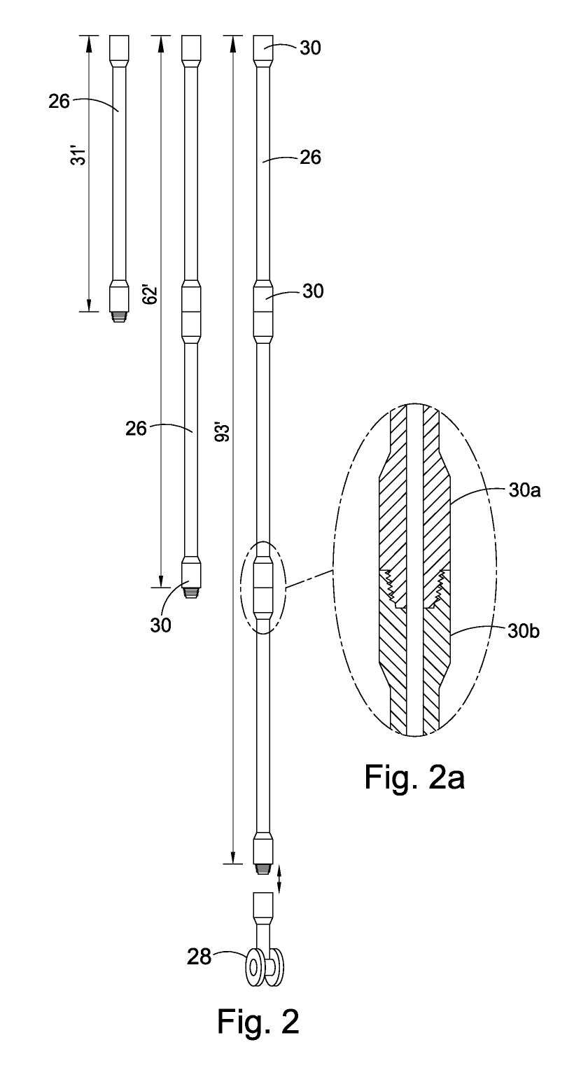

FIG. 3 shows, schematically, a pipe handling apparatus according to an embodiment of the present invention;

FIGS. 4 through 6 show, in schematic plan view, alternative embodiments of racking board for use with the embodiment of FIGS. 3;

FIG. 7 shows an alternative embodiment of pipe handling apparatus being lifted into position on a drilling mast;

FIG. 8 shows the pipe handling apparatus of FIG. 7 in more detail;

FIG. 9 shows the pipe handling apparatus of FIGS. 7 and 8 in partially extended configuration;

FIG. 10 shows the pipe handling apparatus of FIGS. 7-9 in further extended configuration;

FIG. 11 shows the pipe handling apparatus of FIGS. 7-10 mounted on a pair of legs of a drilling mast;

FIG. 12 shows the pipe handling apparatus of FIGS. 7-11 about to grip a pipe; and

FIG. 13 shows the pipe handling apparatus of FIGS. 7-11 gripping a pipe at a well-centre.

### DETAILED DESCRIPTION OF A PREFERRED EMBODIMENT

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.-

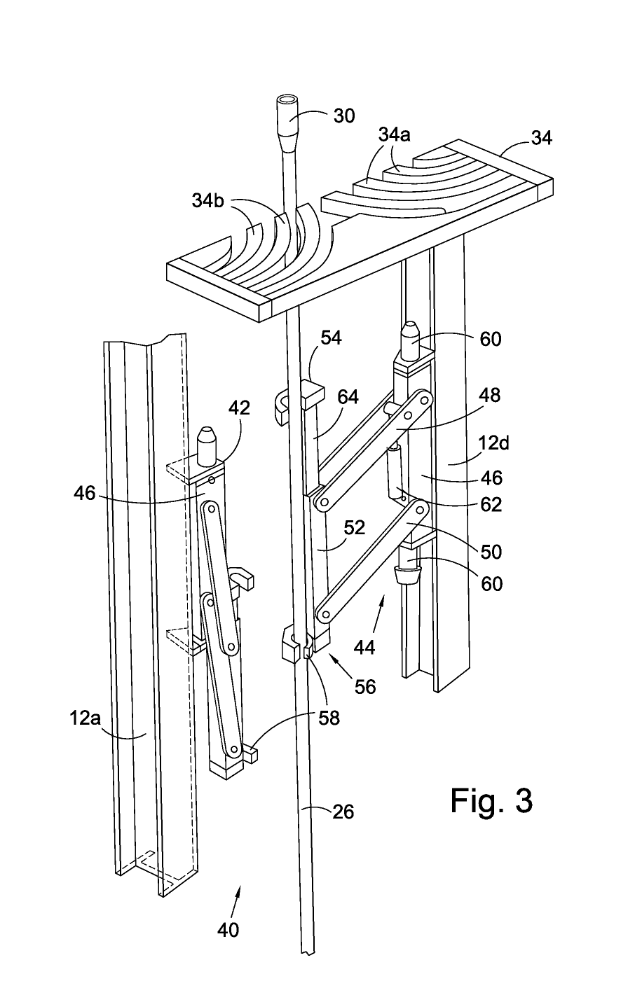

Turning to FIG. 3, this shows part of a mast 10, including racking apparatus according to an embodiment of the present invention.

In accordance with an embodiment of the invention racking apparatus 40 comprises two racking assemblies 42 and 44 that are respectively attached to the two legs 12a and 12d which frame the open side of the mast. Above the racking assemblies is a racking board 34 in which pipes or stands are accommodated. Each of the two assemblies 42 and 44 comprises an upright base member 46 which is mounted for rotational movement on the respective leg 12a or 12d. On the base member 46 are mounted pivoting upper and lower arms 48 and 50, which together support an upright telescopic pipe gripping member 52. At an upper end of the pipe gripping member is a grip head 54, comprising hydraulically operable jaws for gripping a pipe 26, and at a lower end of the pipe gripping member 52 is a guide head 56 which has a retaining finger 58 for guiding and loosely retaining the pipe 26. The pipe is free to slide and rotate with respect to the guide head 56.

The base member 46 is rotated about the leg on which it is mounted by a pair of rotary actuators 60. The upper arm 48 is acted upon by an arm-lift hydraulic cylinder 62 which operates to lift the gripping member 52 out and back, radially from the leg 12. A third degree of movement of a gripped pipe 26 is achieved by the hydraulic telescopic mounting 64 of the grip head 54 on the gripping member 52. This allows the pipe 26 to be raised and lowered translationally with respect to the guide member 56.

With the combination of rotation, radial and translational lift, movement the racking assembly is able to maneuver a pipe 26 between the racking board 34 and the well centre (not shown in this FIG.). The actuators 60, lifting cylinder 62 and telescopic mounting 64 are controlled by a computer (not shown) in a fully automated operation. As an alternative, mechanised controls can be used by an operative in a non-automated operation. Should the apparatus suffer a complete loss of power, one or more operatives can manipulate the apparatus by hand to move the pipe.

In FIG. 3 the racking assembly mounted on the right hand leg 12d is operational to move the pipe 26, whilst the assembly mounted on leg 12a is not active and is in a “parked” configuration. Because of the rotary motion of the gripping member and pipe with respect to the leg of the mast, the racking board has supporting fingers 34a and 34b that are arcuate in shape. In order to achieve sufficient storage for the pipes the racking board has two sets of fingers 34a and 34b which sets extend in opposed arcuate directions. The pair of racking assemblies are able to work together in complementary fashion to access the opposed pairs of racking fingers 34a and 34b.

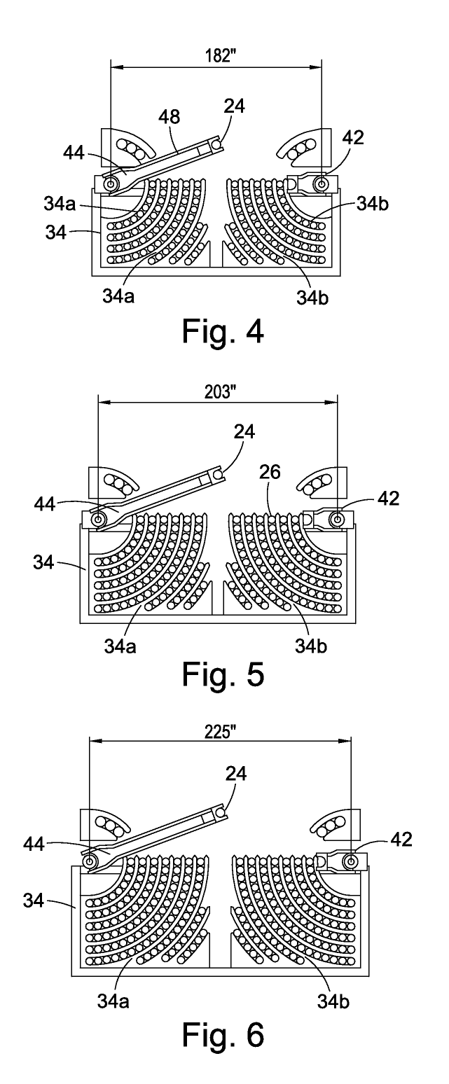

FIGS. 4 to 6 show part of the apparatus of FIG. 3 with different embodiments of racking boards 34, for accommodating different numbers of pipes or stands. In each case, the racking assembly mounted on mast leg 12d is operational and the other racking assembly mounted on mast leg 12a is parked. Working alternately with the two racking assemblies, or else working with one to access all of the pipes in one side of the racking board and then with the other to access all of the pipes in the other side of the racking board, permits all of the pipes to be deployed. Although the racking boards are of different sizes in the three drawings, the racking assemblies are sufficiently versatile in their mobility that the pipes/stands 26 can be retrieved from and stored in any of the locations between the two sets of arcuate support fingers 34a and 34b.

Although in the above described embodiments the racking assemblies are mounted directly onto the legs of the mast, they could alternatively be mounted indirectly on the legs, via an intermediary structure (not shown), for example so as to allow a greater capacity of pipes/stands.

When stands are to be brought from the racking board to the well centre the racking assembly firstly swings towards the racked pipes and selects a stand. The pipe is then gripped and retained, respectively by the grip head 54 and guide head 56 before it is lifted upwards clear of the set back. Then the racking assembly slews around to face the well centre 24 and luffs, so as to present the pipe to the well centre. The pipe is then lowered onto a portion of existing drill string protruding up from the well centre (known as the stick-up) and the racking assembly then releases its grip of the pipe, whilst retaining it in the guide head. The newly presented pipe is then connected to the down well string by threaded engagement using a conventional power tool known as a “roughneck” (the so-called “making up” procedure). The top of the stand is then connected to the travelling assembly and the racking assembly releases the pipe, swings out and finally luffs back before returning to the racked pipes and repeating the process.

The converse procedure involves pulling the stand—usually a triple pipe, from the well centre with the travelling assembly until the bottom of the stand is sufficiently clear (approximately 1 m) from the platform. Then the racking assembly swings in and retains the stand with its guide head. The roughneck then disconnects the stand from the down-well string (the so-called “breaking out” procedure). The grip head then grips the stand, whereupon the travelling assembly is disconnected and the stand is held only by the racking assembly. The racking assembly then retracts a little and slews towards the racking board. When the pipe is located in the appropriate position between support fingers of the racking board it is lowered onto the set back. The grip head 54 then releases its grip and the retaining finger 58 opens to allow the pipe to disengage from the racking assembly, which returns to the well centre to retrieve the next stand.

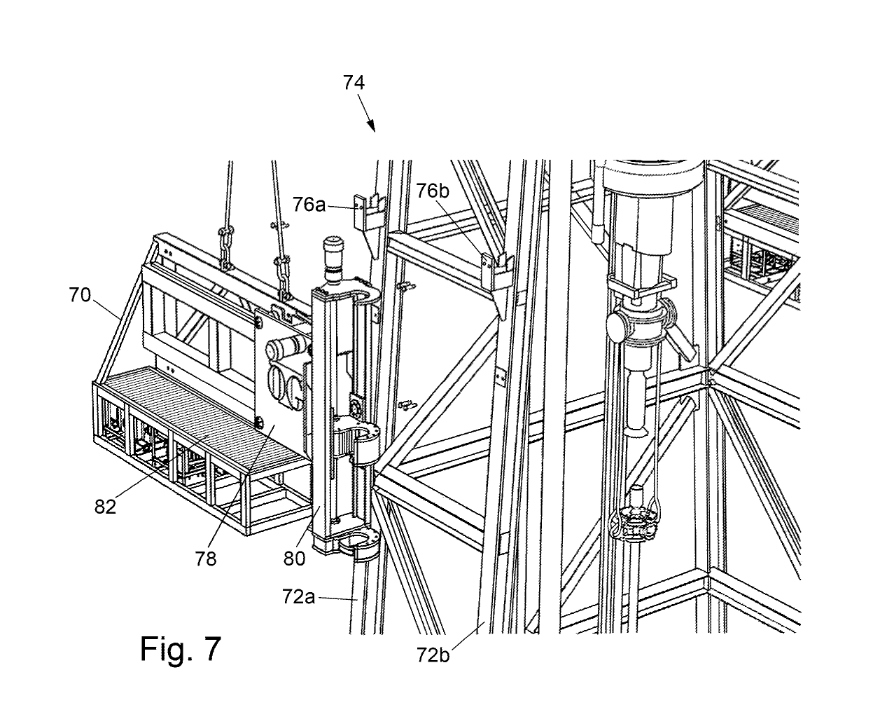

Turning now to FIG. 7 this shows an alternative embodiment of pipe handling apparatus according to the present invention.

The apparatus comprises a main housing 70 which functions as a mounting member and which is mountable on a pair of legs 72a, 72b of a drilling mast 74. During installation the main housing is hoisted into position by a crane (not shown) such that it can be bolted onto two support bracket 76a, 76b on the legs 72a, 72b. Mounted on the main housing 70 is moveable positioning unit in the form of a carriage frame 78 which supports a pipe engaging portion 80 which will be described below. The main housing also comprises a box platform 82 which in use houses a reservoir, motor, pumps and control valves (not shown).

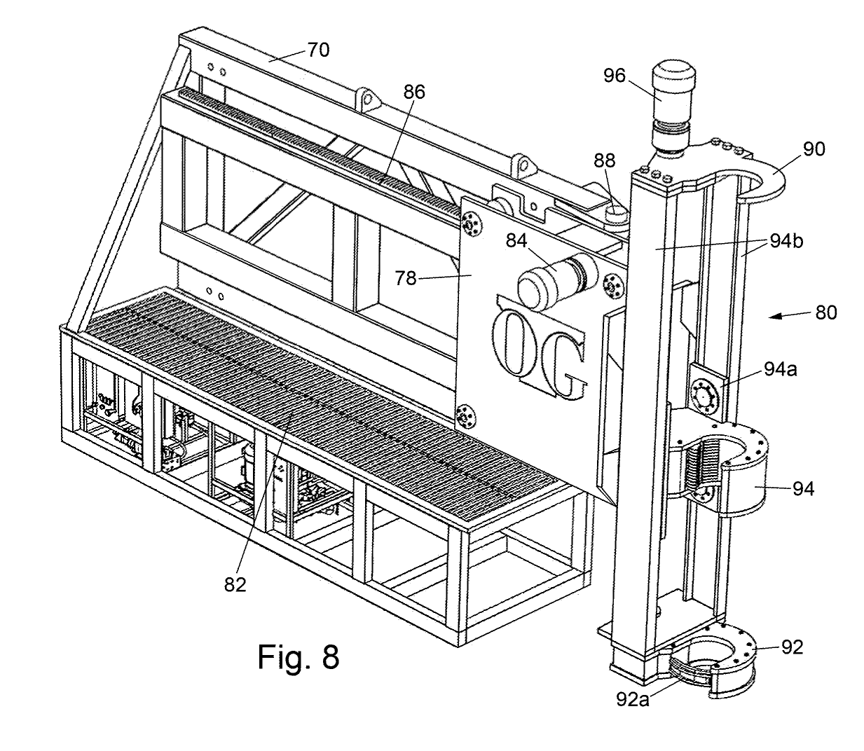

The platform is as described above in relation to the first embodiment and further description thereof is omitted. FIG. 8 omits the mast, for clarity, and shows the main housing in more detailed view. The carriage frame has a drive motor 84 which engages with a drive rack 86 of the handling assembly 80. When the drive motor is actuated the handling assembly 80 may be made to travel linearly with respect to the carriage frame 78.

The carriage frame 78 is mounted rotationally on the main housing and can be made to rotate with respect to the main housing by operation of a rotary actuator 88.

The pipe handling assembly 80 comprises upper and lower guide heads 90 and 92 and a pipe gripping member 94. The upper guide head 90 is a single hook-shaped arm, whilst the lower guide head 92 includes a retaining finger 92a. The pipe gripping member 94 has a hydraulically actuated moveable jaw 94a which is used to grip a pipe in use.

At the top of the handling assembly a motor 96 drives a screw (not shown in this FIG.) for raising and lowering the gripping member 94 with respect to the carriage frame. The gripping member 94 travels up and down on a travel carriage 94a between rails 94b. Then, the gripping member 94 and any pipe which it grips in use, are allowed to move translationally, rotationally and up and down with respect to the legs of the drilling mast on which the apparatus is mounted.

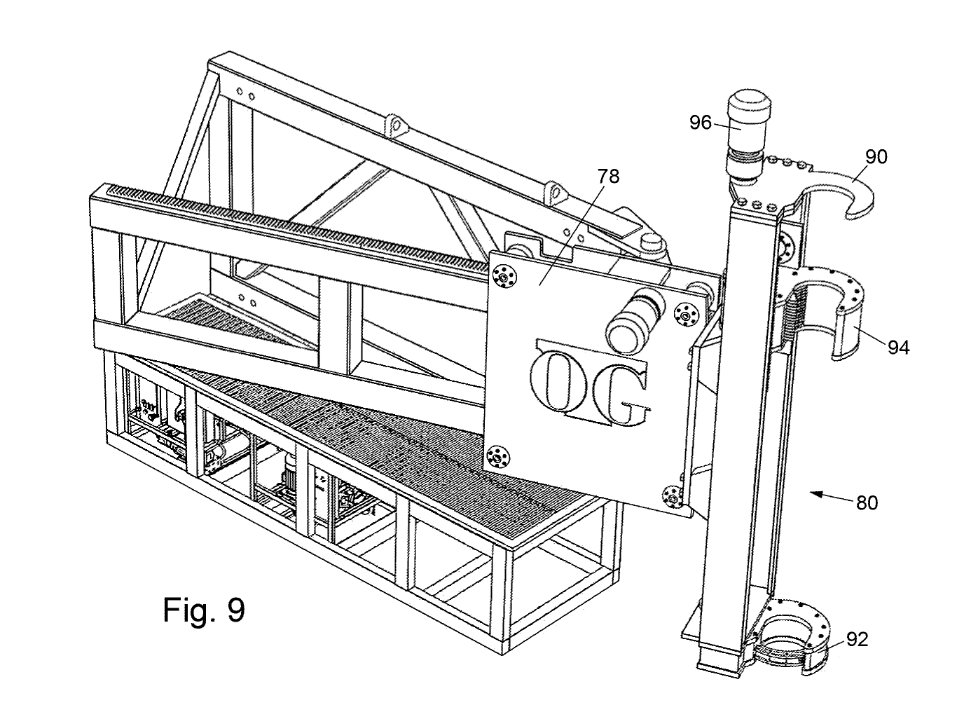

FIG. 9 shows the pipe handling apparatus in a different configuration from that shown in FIG. 8. The carriage frame 78 has pivoted away from the main housing 70. Also the gripping member 94 has been raised in relation to the guide heads 90 and 92 by motor 96.

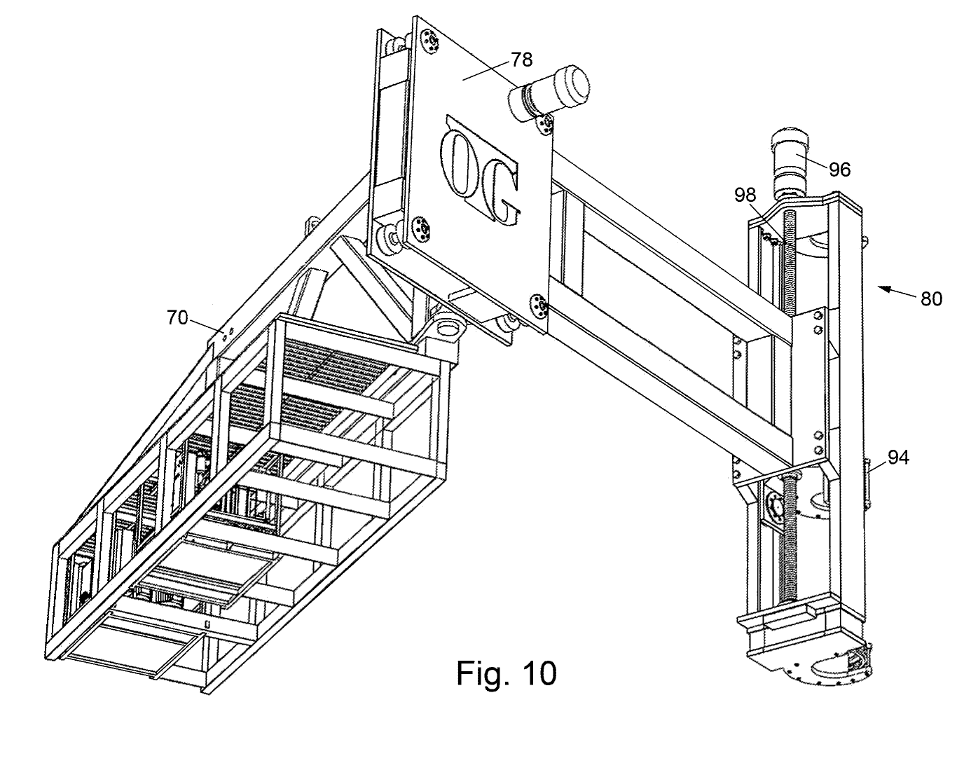

FIG. 10 is a different view of the apparatus shown in FIGS. 7-9. Seen from below, the drawing shows the carriage frame 78 pivoted further from the main housing 70 and with the pipe gripping assembly 80 at maximum extension from the carriage frame. Screw 98, which is driven by motor 96 to raise and lower the gripping member 94, can clearly be seen.

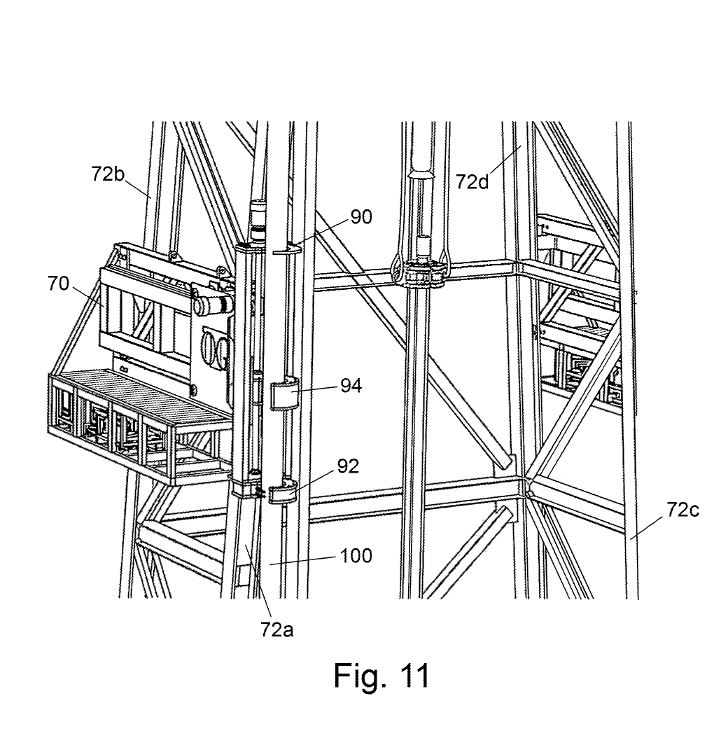

FIG. 11 shows the apparatus mounted on the legs 72a and 72b of the mast. Drilling pipe portion 100 is gripped by the gripping member 94. The pipe portion 100 is held securely by the moveable gripping member 94 and may slide upward and downward through the upper and lower guide heads 90 and 92. The drawing also shows another set of the pipe handling apparatus mounted on opposed pairs of legs 72c and 72d. The detail is omitted for clarity.

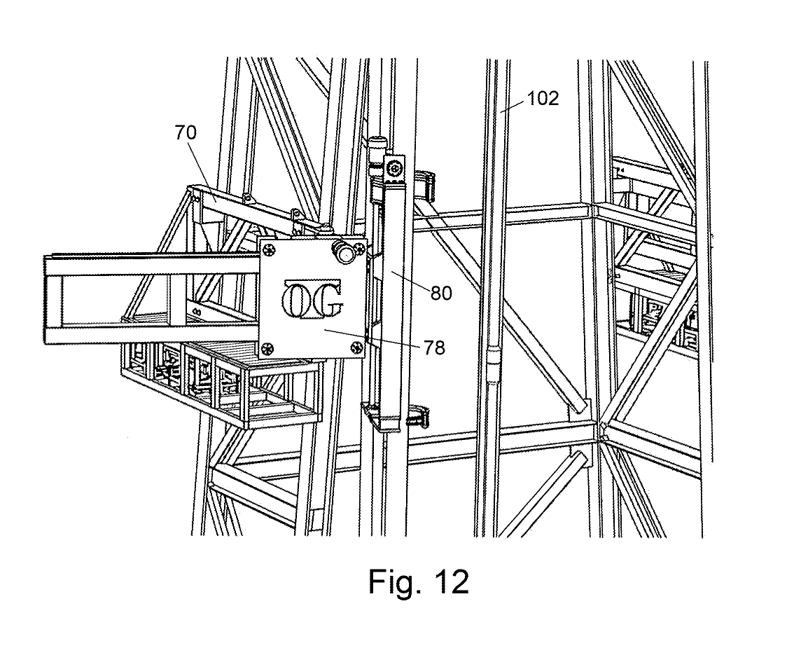

FIG. 12 shows the pipe handling apparatus of FIG. 11 moving the pipe towards a drill centre for engagement with a drill string 102. The carriage frame 78 has pivoted out from the housing 70 but the pipe gripping assembly 80 has yet to extend from the carriage frame 78.

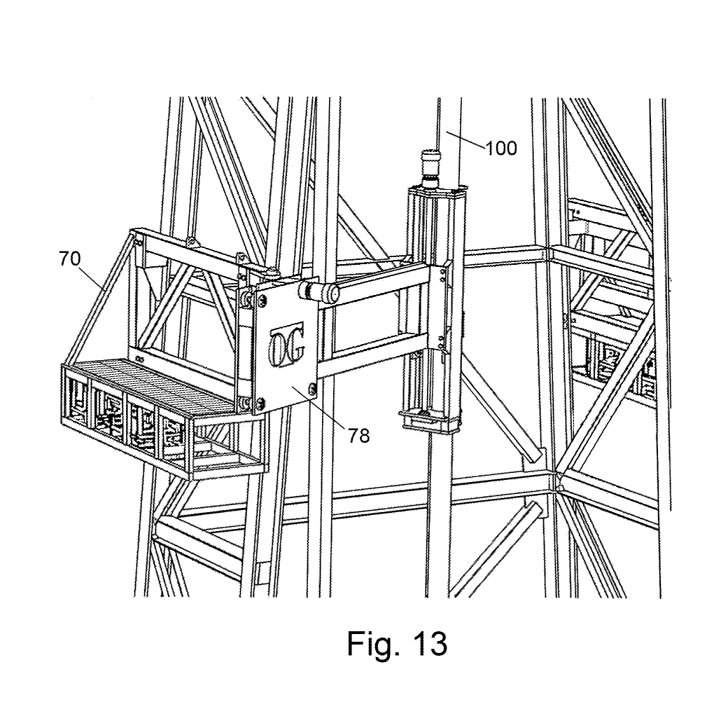

Finally, FIG. 13 shows the apparatus presenting the drill pipe portion 100 at well centre. The carriage frame is pivoted well away from the main housing and the gripping assembly so is fully extended towards well centre.

The apparatus of the embodiment moves pipe stands between the racking assemblies and well centre in the same way as is detailed above in relation to the previous embodiment.

In the embodiments described above the mechanical parts are controlled hydraulically. However, depending upon the environment and the context, an alternative form of mechanisation, and/or of control, could be employed.

Embodiments of the present invention provide a simple, relatively lightweight racking assembly that can be readily mounted on, and demounted from a leg of a mast. The apparatus is ideally automated and under the control of a computer. If a controlling computer fails the apparatus can be controlled mechanically using its hydraulic systems in a non-automated manner. Furthermore, if the hydraulics fail the apparatus can be used manually, thus ensuring that down-time is at least minimised.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

Further, the Abstract at the end of this disclosure is provided to allow the reader to quickly ascertain the nature of the technical disclosure. It is submitted with the understanding that it will not be used to interpret or limit the scope or meaning of the claims.

1. Pipe handling apparatus for handling drilling pipes, the apparatus comprising:
a pipe engaging portion,
a movable positioning unit configured to move the pipe engaging portion, and
a mounting member configured to mount the apparatus on a leg of a drilling mast,
wherein the apparatus is configured to transport drilling pipes to and from a pipe storage racking board having supporting fingers that are arcuate in shape and define arcuate-shaped tracks for receiving and storing drilling pipes transported by the apparatus.

2. The apparatus according to claim 1, wherein the positioning unit is arranged in use to move the pipe engaging portion both circumferentially and radially with respect to the mounting member.

3. The apparatus according to claim 1, wherein the pipe engaging portion comprises a gripping member for gripping a drilling pipe, and a retaining member for retaining a drilling pipe.

4. The apparatus according to claim 3, wherein the gripping member and the retaining member are mounted telescopically with respect to each other.

5. The apparatus according to claim 3, wherein the gripping member comprises gripping jaws.

6. The apparatus according to claim 3, wherein the retaining member comprises a collar and a retaining finger.

7. The apparatus according to claim 1, wherein the positioning unit is arranged in use to move the pipe engaging portion translationally, rotationally and up and down with respect to the legs of the drilling mast.

8. The apparatus according to claim 7, wherein the pipe engaging portion comprises a gripping member allowed to move translationally, rotationally and up and down with respect to the legs of the drilling mast.

9. The apparatus according to claim 1, wherein the pipe engaging portion additionally comprises a guide head.

10. The apparatus according to claim 1, wherein the positioning unit comprises upper and lower arm portions having proximal ends which are connected to the mounting member, and distal ends which are connected to the pipe engaging portion.

11. The apparatus according to claim 1, wherein the positioning unit is connected to lifting/lowering means comprising an hydraulic actuator.

12. The apparatus according to claim 1, wherein the positioning unit comprises a carriage frame attached to the mounting portion and rotatably mounted thereon.

13. The apparatus according to claim 12, wherein the carriage frame carries a drive rack which is arranged for translational movement with respect to the carriage frame.

14. The apparatus according to claim 1, wherein the mounting member is mountable for rotary movement with respect to a leg of the mast.

15. The apparatus according to claim 1, wherein the apparatus includes a rack for storing drilling pipes.

16. The apparatus according to claim 15, wherein the rack comprises a plurality of slots for accommodating plural pipes, the slots being arranged in a substantially parallel, radial configuration.

17. A method of transporting drilling pipes between a pipe storage location and an operational location in a drilling rig, the method comprising:
releasably engaging a pipe with pipe engaging means; and
using a positioning unit to move the pipe engaging means in at least radial and circumferential directions with respect to a leg of a drilling mast on which the unit is mounted, wherein the pipe storage location in the drilling rig racking board having supporting fingers that are arcuate in shape and define arcuate-shaped tracks for receiving and storing drilling pipes.

18. The method according to claim 17, comprising gripping the pipe using a gripping member, and retaining the pipe using a retaining member, of the pipe engaging means.

19. The method according to claim 18, comprising moving the gripping member and the retaining member telescopically with respect to each other.

20. The method according to claim 17, comprising transporting pipes between a racking board and a well centre of a drilling rig.

21. A method according to claim 17, comprising transporting pipes to and from a racking board at least partly in a radial motion so that the pipes are placed in, or removed from, a racking board having one or more radially configured pipe-accommodating slots.
